(19) United States
(12) Patent Application Publication
(10) Pub. No.: US 2024/0280147 A1
(43) Pub. Date: Aug. 22, 2024

(54) HYDRAULIC ASSEMBLY, FRICTION CLUTCH AND METHOD FOR OPERATING A FRICTION CLUTCH

(71) Applicant: Schaeffler Technologies AG & Co. KG, Herzogenaurach (DE)

(72) Inventor: Marco GRETHEL, Bühlertal (DE)

(73) Assignee: Schaeffler Technologies AG & Co. KG, Herzogenaurach (DE)

(21) Appl. No.: 18/293,808

(22) PCT Filed: Jul. 13, 2022
(86) PCT No.: PCT/DE2022/100501

§ 371 Date: Jan. 31, 2024

(30) Foreign Application Priority Data
Aug. 10, 2021 (DE) 102021120717.7

(51) Int. Cl. F16D 48/02; F16D 25/0635; F16D 25/12

(52) U.S. Cl. CPC F16D 48/02; F16D 25/0635; F16D 25/123; F16D 2048/0221; F16D 2048/0227

(57) ABSTRACT

An assembly for driving a friction clutch, having a hydraulically driveable stepped piston, with: a pump driving the stepped piston, which has a working piston moveably arranged in a working chamber that divides it into first and auxiliary working chambers. The working piston is mechanically connected to an auxiliary working piston and hydraulically driveable via a second working chamber. A control valve is arranged between the stepped piston and pump. A first line path leads from the pump to the second working chamber, and a second line path leads from the pump to the first working chamber. The stepped piston has a working tappet which acts on the friction clutch. The first and second line paths are connected via a first line section of the supply line and a multi-port control valve, which has two valve positions, and the first line section is at least partially blocked in one valve position.

### CROSS-REFERENCE TO RELATED APPLICATIONS

This application is the U.S. National Phase of PCT Appln. No. PCT/DE2022/100501, filed Jul. 13, 2022, which claims priority to German Patent Application No. 10 2021 120 717.7, filed Aug. 10, 2021, the entire disclosures of which are incorporated by reference herein.

### TECHNICAL FIELD

The disclosure relates to a hydraulic assembly, a friction clutch and a method for operating a friction clutch.

### BACKGROUND

So-called friction clutches are known in the prior art. For example, DE 10 2011 108649 A1 discloses a torque transmission unit having a friction clutch and a hydraulic actuation system, which comprises a stepped piston unit having a stepped piston, which comprises a first piston portion that is movable in a first pressure chamber and has a first, smaller hydraulically active effective area and a second piston portion that is movable in a second pressure chamber and has a second, larger hydraulically active effective area. Here, the first and second pressure chambers are fluidically connected by means of an overflow line, as a function of a position of the first piston portion. According to DE 10 2011 108649 A1, an actuating piston cooperates with the friction clutch to selectively actuate the torque transmission unit.

Furthermore, DE 10 2015 20 4673 B3 discloses a hydraulic assembly for a friction clutch, which comprises a switching unit having an input, having a closable first output and having a closable second output. The switching unit is fluidically connected to the volume flow source via the input by means of the hydraulic supply line, with the lower input pressure being converted into a higher output pressure by means of a pressure intensifier.

However, the aforementioned solutions do not constitute an optimal solution as regards rapid passage through the initially contactless approach phase with very low force up to the bite point and the subsequent contact and force transmission phase with high force application and very little or no change in the position of the working piston.

### SUMMARY

The object is therefore to provide a hydraulic assembly for a friction clutch that enables these two steps or phases to run better.

For this purpose, a hydraulic assembly having one or more of the features disclosed herein, a friction clutch having one or more of the features disclosed herein and a method having one or more of the features disclosed herein are provided. Advantageous embodiments are set out below and in the claims.

The hydraulic assembly according to the disclosure for driving a friction clutch comprises a hydraulically drivable stepped piston and a pump driving at least the stepped piston, wherein the stepped piston comprises a working piston having a piston chamber, wherein the working piston displaceably, in particular linearly displaceably, arranged in the piston chamber divides this piston chamber into a first working chamber (main chamber) and an auxiliary chamber. In this respect, the auxiliary chamber can be a closed or partially open chamber, this auxiliary chamber in a structurally simple embodiment being merely a guide chamber, for example a cylindrical guide chamber. Such a guide chamber is completely or partially open at the end opposite the working piston. The working piston is moreover mechanically connected to an auxiliary working piston or has a portion which is designed as an auxiliary piston and which can be driven hydraulically via a second working chamber. During flooding and/or pressure build-up in the two working chambers, these drive the stepped piston in a common direction engaging the friction clutch. The inflow of hydraulic fluid and build-up of pressure in the auxiliary chamber act in the opposite direction, i.e. disengaging the friction clutch.

In the present case, “friction clutch” should not be understood as limiting. Rather, “friction clutch” should be understood quite generally as meaning a torque transmission device in the form of a frictional and/or interlocking clutch or brake.

Furthermore, at least one control valve is included, which is arranged in at least one line path between a working chamber of the stepped piston and the pump. A first line path leads via a first supply line from the pump to the second, smaller working chamber; there is no flow through the control valve in this case. A second line path leads from the pump via the first supply line, the control valve and a second supply line to the first, larger working chamber. The stepped piston has a (working) plunger which is guided through the auxiliary chamber and which is likewise moved linearly and by means of which the friction clutch can be acted on mechanically. The first and second line paths are connected via a first line portion of the second supply line, which line portion branches off from the first supply line, and a control valve. The control valve can assume at least two valve positions, with the first line portion of the second supply line being at least partially blocked in at least one of the valve positions.

The advantage here is that, when the piston moves during the approach phase, also called the air travel region, only the smaller volume of the second working chamber of the stepped piston is filled by the pump, such that the working piston can be displaced quickly. Application of the larger volume and thus initiation of a high contact pressure over the large effective area is only initiated on or shortly before or shortly after reaching of the bite point (TP), at which the line path between the pump and the first working chamber (main working chamber) is opened by means of the control valve.

An improved embodiment consists in that, parallel to the control valve, there is a further line connection through a first check valve between the first and the second line path. This can be used to deliver hydraulic fluid from the large, first working chamber, bypassing and/or parallel to the control valve, to the tank during the opening movement of the stepped piston, in particular during negative pressure operation of the pump.

According to a further improved embodiment, the second line path leads from the working chamber, via a second line portion of the second supply line, via a branch node parallel to the control valve and a discharge line, and into a tank. Ideally, a second check valve is arranged in the discharge line between the branch node and the tank and provides a blocking action in the direction of the tank. As a result, the drainage line becomes a pressure equalization line in reverse or suction mode, via which hydraulic fluid can flow into the system if necessary.

According to a further improved embodiment of the hydraulic assembly, the control valve in the second valve position either completely blocks, i.e. interrupts, the first line portion of the second supply line, or establishes a connection with a check valve function that allows a flow from the second line path into the first line path and, in the opposite direction, blocks, in particular blocks in pressure-dependent manner, namely the first line path from the pump to the first working chamber (main working chamber.)

In a further embodiment, the second working chamber is smaller than the working chamber, preferably the second working chamber is at least 10% smaller, in particular more than 20% smaller than the first working chamber (main working chamber) and/or the effective areas of the working chambers are analogously in the ratio of 0.9 or 0.8 to each other.

Advantageously, the control valve is a passive control valve which switches from one valve position to the other valve position when a defined fluid pressure is reached in one of the two supply lines, in particular in the first supply line. In an alternative embodiment, the control valve is an electrically switchable solenoid valve.

In a further advantageous embodiment, a displacement sensor is arranged on or at the working piston of the stepped piston and the displacement sensor information is used to control the control valve. A further improvement consists in the fact that the hydraulic assembly is monitored by evaluating the fluid pressure in the first and/or the second supply line and the data from the displacement sensor on the working piston. Here, TARGET values/ranges are compared with ACTUAL values/ranges, and control and/or warning information is derived for the vehicle or the operator.

According to a further embodiment and/or improvement, at least one pressure sensor is provided in one of the lines or line portions, such that the bite point can be identified and/or determined via a pressure measurement. This determination is made by identifying a pressure gradient and/or an absolute pressure in a line.

In a further embodiment, provision is made for a cooling and lubrication line to branch off from the first supply line and upstream of the control valve, with a (fluid) orifice being arranged in the cooling and lubrication line, via which orifice only a very little fluid flow is guided. An improvement consists in the fact that the free end of the cooling and lubrication line has a diffuser, which is arranged adjacent to a free end of the working piston of the stepped piston, and is directed in particular towards the friction clutch to be engaged and disengaged. The diffuser can in particular be a slit nozzle or a series of individual nozzles.

In a further embodiment, a tank is arranged upstream of the pump, which is used as a hydraulic reservoir and which is connected to the pump via a supply line. The pump is advantageously a double-acting pump that can operate by both pressing and sucking on the first supply line. The tank is advantageously a closed vessel that can be operated under negative pressure of up to 0.8 bar, ideally up to 0.5 bar.

The disclosure further encompasses a friction clutch having an axis of rotation for releasably connecting an output shaft to a consumer, which comprises or has the following
at least one friction package having at least one pressure plate and at least one corresponding friction disk, via which a torque can be transmitted in the pressed-on state, and a hydraulic assembly which is designed according to any one of the variants set out above, and wherein the stepped piston is configured to press on the at least one friction package. The consumer can also be a brake or act as a brake.

Furthermore, the disclosure includes a method for operating a friction clutch, wherein a pressure plate is moved against a consumer-side friction disk by means of a stepped piston which has effective areas of different sizes. The stepped piston has at least one first working chamber (main working chamber) and an auxiliary chamber. The auxiliary chamber is opposite the first working chamber and moves in the opposing direction when flooded. Furthermore, a second working chamber is included, which acts on the stepped piston in the same direction to the first working chamber when flooded. Here, the propulsion to move the stepped piston and engage the friction clutch takes place in at least two steps.

In the first step, the working piston is driven faster with the same drive power of a drive unit, in particular a pump, than in the second step. For this purpose:
in the first step, the (hydraulic) fluid is directed into the second, smaller working chamber, and
in a second step, (hydraulic) fluid is additionally directed into the first, larger working chamber, wherein ideally the (piston) effective area of the first working chamber is larger than the (piston) effective area of the second working chamber. In the second step, the control valve is switched to a first valve position allowing passage, with the control valve in the first step being switched to an at least partially blocking, in particular completely blocking, second valve position. In an improved variant of the method, the stepped piston is returned to disengage the friction clutch in such a way that the pump operates with suction on the first supply line. Any check valves that may be present are opened and flow passes through them. The hydraulic fluid is discharged into a tank or reservoir.

Advantageously, in this respect a hydraulic assembly according to one of the aforementioned variant embodiments is used or operated.

### BRIEF DESCRIPTION OF THE DRAWINGS

The disclosure is explained by way of example below with reference to the drawings, in which:

FIGS. 1.1 and 1.2 show an embodiment of the hydraulic assembly as a flow diagram in two valve positions;

FIGS. 2.1 and 2.2 show an improved embodiment over FIGS. 1.1 and 1.2 as a flow diagram in two valve positions;

FIG. 3 shows a schematic course of a clutch characteristic curve of a friction clutch.

### DETAILED DESCRIPTION

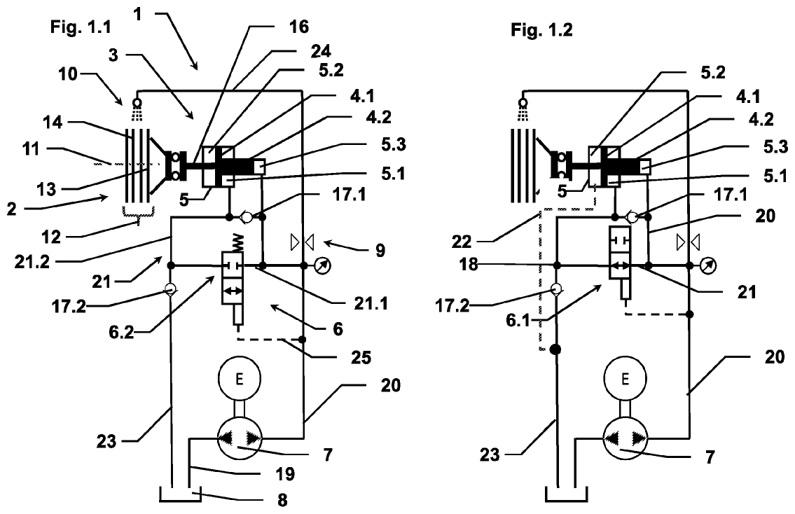

In FIGS. 1.1 and 1.2, the hydraulic assembly 1 is shown in two valve positions 6.1 and 6.2, respectively. The friction clutch 2 is actuated by the stepped piston 3. The stepped piston 3 has a working piston 4.1, which is mounted in a piston chamber 5 and moves linearly. The piston chamber 5 is divided into a first working chamber 5.1 and an opposing auxiliary chamber 5.2 by the working piston 4.1. The auxiliary chamber 5.2 shown in FIG. 1.1 is ventilated in a manner not shown. Furthermore, the piston chamber 5 has a second working chamber 5.3, in which an auxiliary working piston 4.2 is guided. Pressure builds up in the two working chambers 4.1, 4.2 via the respective effective areas in the direction of the friction clutch 2, thus closing the friction package 12. For this purpose, the first working piston 4.1 has a (working) plunger 16, which carries the bearing arrangement 11 for the pressure plate 13 and the pressure plate itself 13.

The first line path leads from the pump 7, parallel to the control valve 6, into the second, smaller working chamber 5.3 of the stepped piston 3. The second supply line path from the pump 7 to the first working chamber 5.1 is divided in two and leads via the first supply line 20 from the pump 7 to a line node, and there via the second supply line 21 to or through the control valve 6, which in the present case is configured as a 2/2-way valve. Downstream of the control valve 6, the second supply line 21 leads to the first working chamber 5.1. A first check valve 17.1 is provided between the first and second line paths, parallel to the control valve 6, which connects the first supply line 20 to the second line portion 21.2 of the second supply line 21. A further, second check valve 17.2 is provided in the discharge line 23, which opens into the second supply line 21 at the line node between the first and second line portions. As can be seen as a dashed line in FIG. 1.2, an auxiliary line 22 can be provided from the auxiliary chamber 5.2, which opens into the tank 8 and/or the discharge line 23. This can be used, for example, to lubricate the auxiliary chamber 5.2.

The pump 7 is likewise connected to the tank 8 via a suction line 19. Furthermore, a coolant and lubricant line 24, in which an orifice 9 is provided, leads to a diffuser 10, which is arranged opposite the friction clutch 2 and lubricates and cools the friction package 12. The naming of the elements and especially the lines refers to the work step when pressure is built up. This is not intended to be limiting and is only intended to facilitate understanding. Taking the “suction line 19” as an example, it is immediately obvious to a person skilled in the art that in the suction mode of the pump 7, when it is operating with negative pressure on the first supply line 20, the “suction line 19” is operated as a “pressure line”, without it being renamed for this purpose.

In the starting position, with the friction package 12 disengaged, the control valve 6 is biased into and held in the valve position 6.2 by the spring 6.1, as shown in FIG. 1.1. The pump 7 delivers into the first supply line 20 into the smaller, second working chamber 5.3, and the control valve 6 blocks the second supply line 21 to the first, larger working chamber 5.1. The working piston 4.1 is driven by the auxiliary piston 4.2 and displaced to the left. During this travel, hydraulic fluid is sucked from the tank 8, the discharge line 23 and the second check valve 17.2 into the growing first working chamber 5.1.

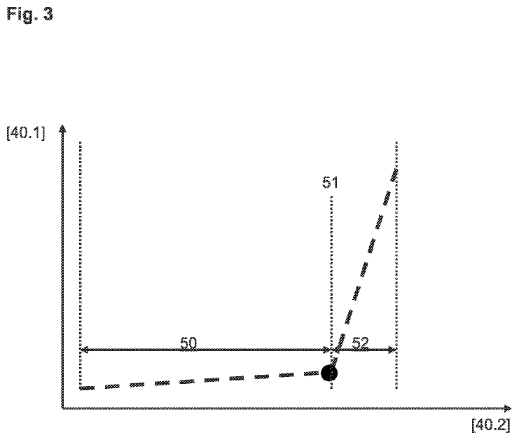

Feed is very fast due to the quickly filling second, small working chamber. The friction package 12 comes into contact, such that feed largely ends and the switching point 51 (FIG. 3) is reached. From a defined pressure or pressure increase in the first supply line 20, which is transmitted by means of the control line 25, the control valve 6 switches to the first valve position 6.1. This is the valve position for the phase with high contact pressure and little or no displacement of the stepped piston 3. The control valve 6 could also be designed as a solenoid valve and could be alternatively driven.

For disengagement of the friction package 12 through return movement of the working piston 4.1, the pump 7 is put into suction mode such that it applies suction to the first supply line 20 and thus to the entire supply line path, whereby the working piston 4.1 moves to the right and at the same time the auxiliary chamber 5.2 grows and fills with hydraulic fluid from the tank 8. The sequences are analogous to the previous steps. Via the two check valves 17.1 and 17.2, a pressure equalization in the line system can be established in both valve positions 6.1, 6.2 or the targeted return movement of the stepped piston can be initiated by a difference in resistance in the line system. Advantageously, in suction mode, a pressure gradient relative to the first working chamber 5.1 is provided through the direct first line path to the second working chamber 5.3 via the control valve 6 or the check valves 17.1 and 17.2, such that the pump 7 generates a greater negative pressure in the second working chamber 5.3 in suction mode. During normal operation, however, no negative pressures or only very slight negative pressures are built up because the energy stored in the clutch by engagement ensures that the fluid is forced out of the working chambers 5.1, 5.3. The pump 7 is driven substantially in the opposite direction, so that the (hydraulic) fluid can flow in a defined manner, i.e. in the active delivery direction of the pump 7, and the pressure in the line 20 can be reduced in a targeted manner.

In an embodiment which is not shown, the auxiliary chamber 5.2 can be fluidically pressurized for resetting the stepped piston 3, and in an alternative embodiment a spring or an elastomer is arranged in the auxiliary chamber 5.2, such that the working piston 4 is subjected to an opening force.

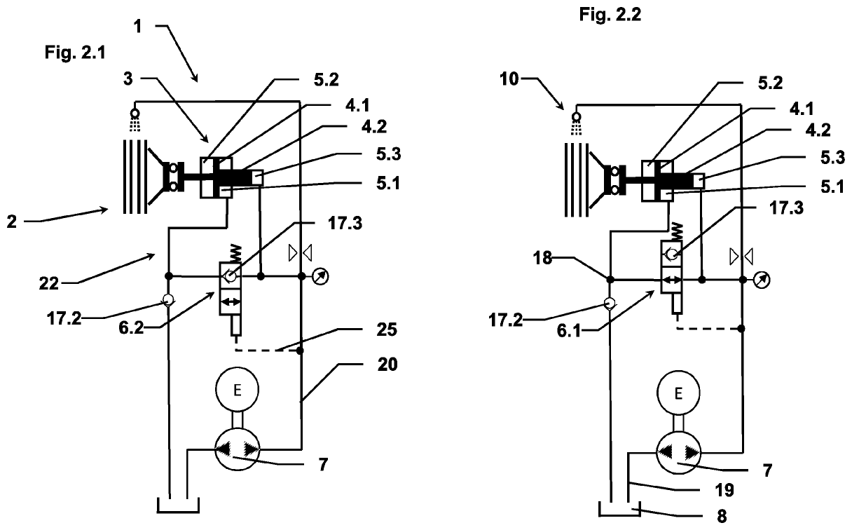

The embodiment shown in FIGS. 2.1 and 2.2 corresponds to those in FIGS. 1.1 and 1.2, wherein the control valve 6 has the function of a check valve instead of a completely blocking function in the first valve position 6.1, such that bypassing as described above via a first check valve 17.1 can be omitted. In the second valve position 6.2, an integrated check valve 17.3 is provided in the control valve 6.

Finally, FIG. 3 shows a greatly simplified clutch characteristic curve. The force or pressure is plotted on the axis (y-axis) marked 40.1 and the distance or volume is plotted on the axis marked 40.2 (x-axis). In the approach step 50, a long distance is traveled until the bite point 51 is reached, with only a slight increase in force/pressure. In the pressing phase 52, the conditions are reversed. If the distance/volume progress is small, a large pressure increase occurs.

### LIST OF REFERENCE SIGNS

1 Hydraulic assembly
2 Friction clutch
3 Stepped piston
4 Working piston
   4.1 Working piston
   4.2 Auxiliary working piston
5 Piston chamber
   5.1 Working chamber, first
   5.2 Auxiliary chamber
   5.3 Working chamber, second
6 Control valve
   6.1 Valve position, first
   6.2 Valve position, second
7 Pump
8 Tank
9 Orifice
10 Diffuser
11 Bearing arrangement
12 Friction package
13 Pressure plate
14 Friction disk
15 Switching valve
16 Working plunger
17 Check valves
   17.1 Check valve, first
   17.2 Check valve, second
   17.3 Check valve, integrated
18 Branch node
19 Supply line
20 Supply line, first
21 Supply line, second
   21.1 Line portion, first
   21.2 Line portion, second
22 Auxiliary line
23 Discharge line
24 Cooling and lubrication line
25 Control line
40.1 y-axis
40.2 x-axis
50 Approach step
51 Bite point
52 Pressing phase

1. A hydraulic assembly for driving a friction clutch, the hydraulic assembly comprising:
a hydraulically drivable stepped piston;
a pump driving the stepped piston;
the stepped piston comprises a working piston with a piston chamber, the working piston is displaceably arranged in the piston chamber and divides said piston chamber into a first working chamber and an auxiliary chamber, and the working piston is mechanically connected to an auxiliary working piston or comprises such an auxiliary working piston, which is driveable hydraulically via a second working chamber;
a control valve arranged in at least one line path between at least one of the first or second working chambers of the stepped piston and the pump;
a first line path leads via a first supply line from the pump to the second working chamber and a second line path leads from the pump via the first supply line, the control valve and a second supply line to the first working chamber;
the stepped piston has a working plunger guided through the auxiliary chamber, by which working plunger the friction clutch is adapted to be acted upon mechanically; and
the first line path and the second line path are connected via a first line portion of the second supply line and the control valve, the control valve has at least two valve positions, and in at least one of the valve positions the first line portion of the second supply line is at least partially blocked.

2. The hydraulic assembly according to claim 1, further comprising a line connection, parallel to the control valve, through a first check valve between the first and the second line path.

3. The hydraulic assembly according to claim 1, wherein the second line path leads from the working chamber, via a second line portion of the second supply line, via a branch node parallel to the control valve and a discharge line into a tank, and a second check valve is arranged in the discharge line and between the branch node and the tank, the check valve provides a blocking action in a direction of the tank.

4. The hydraulic assembly according to claim 1, wherein the control valve in a second of the at least two valve positions either
completely blocks the first line portion of the second supply line or
establishes a connection with a check valve function that blocks the first line path from the pump to the working chamber.

5. The hydraulic assembly according to claim 1, wherein the second working chamber is smaller than the working chamber.

6. The hydraulic assembly according to claim 1, wherein the control valve is a passive control valve which switches from a first of the at least two valve positions to a second of the at least two valve positions when a fluid pressure is reached in one of the first or second supply lines, and the control valve is a solenoid valve.

7. The hydraulic assembly according to claim 1, further comprising a cooling and lubrication line that branches off from the first supply line and upstream of the control valve, and an orifice is arranged in the cooling and lubrication line.

8. A friction clutch having an axis of rotation for releasably connecting an output shaft to a consumer, the friction clutch comprising:
at least one friction package having at least one pressure plate and at least one corresponding friction disk, via which a torque is transmittable in a pressed-on state; and
at least one hydraulic assembly according to claim 1, wherein the stepped piston is configured to press on the at least one friction package.

9. A method for operating a friction clutch, the method comprising:
moving a pressure plate against a consumer-side friction disk by a stepped piston, wherein the stepped piston comprises an auxiliary chamber, a first working chamber and a second working chamber, a movement for engaging the friction clutch takes place in at least two steps, the working piston in a first step with a same drive power of a drive unit, occurs faster than in a second step,
a first step comprises directing the fluid into a second working chamber, and
a second step comprises, additionally directing the fluid into the first working chamber, wherein the second working chamber is smaller than the first working chamber, and wherein
in the second step, switching the control valve to a first valve position allowing passage and
in the first step, switching the control valve to an at least partially blocking second valve position.

10. The method according to claim 9, wherein the pump operates with suction on the first supply line when the stepped piston is returned to disengage the friction clutch.

11. (canceled)

12. A hydraulic assembly for driving a friction clutch, the hydraulic assembly comprising:
a hydraulically drivable piston including a working piston with a piston chamber, the working piston is displaceably arranged in the piston chamber and divides said piston chamber into a first working chamber and an auxiliary chamber, and the working piston is mechanically connected to an auxiliary working piston or comprises such an auxiliary working piston that is driveable hydraulically via a second working chamber;
a pump for driving the piston;
a control valve arranged in at least one line path between at least one of the first or second working chambers of the piston and the pump;
a first line path leads via a first supply line from the pump to the second working chamber and a second line path leads from the pump via the first supply line, the control valve and a second supply line to the first working chamber;
the piston has a working plunger guided through the auxiliary chamber by which the friction clutch is adapted to be acted upon mechanically; and
the first line path and the second line path are connected via a first line portion of the second supply line and the control valve, the control valve has at least first and second valve positions, and in at least one of the first or second valve positions the first line portion of the second supply line is at least partially blocked.

13. The hydraulic assembly according to claim 12, further comprising a line connection, parallel to the control valve, through a first check valve between the first line path and the second line path.

14. The hydraulic assembly according to claim 12, wherein the second line path leads from the working chamber, via a second line portion of the second supply line, via a branch node parallel to the control valve and a discharge line into a tank, and a second check valve is arranged in the discharge line and between the branch node and the tank, and the check valve provides a blocking action in a direction of the tank.

15. The hydraulic assembly according to claim 12, wherein the control valve in the second valve position either
completely blocks the first line portion of the second supply line or
establishes a connection with a check valve function that blocks the first line path from the pump to the working chamber.

16. The hydraulic assembly according to claim 12, wherein the second working chamber is smaller than the working chamber.

17. The hydraulic assembly according to claim 12, wherein the control valve is a passive control valve which switches from the first valve position to the second valve position when a fluid pressure is reached in one of the first or second supply lines.

18. The hydraulic assembly according to claim 17, wherein the control valve is a solenoid valve.

19. The hydraulic assembly according to claim 12, further comprising a cooling and lubrication line that branches off from the first supply line and upstream of the control valve, and an orifice is arranged in the cooling and lubrication line.
